(19) United States
(12) Patent Application Publication
(10) Pub. No.: US 2025/0252512 A1
(43) Pub. Date: Aug. 7, 2025

(54) ELECTRIC VEHICLE CHARGING PAYMENT DEVICE, SYSTEM, AND METHOD OF USING

(71) Applicants: Frank Scozzafava, Niagara Falls, NY (US); Ho Ting Wong, Zhejiang (CN)

(72) Inventors: Frank Scozzafava, Niagara Falls, NY (US); Ho Ting Wong, Zhejiang (CN)

(21) Appl. No.: 19/044,587

(22) Filed: Feb. 3, 2025

Related U.S. Application Data
(60) Provisional application No. 63/548,752, filed on Feb. 1, 2024.

(51) Int. Cl. G06Q 50/06; B60L 53/16; B60L 53/66; G06K 7/14; G06Q 20/18; G06Q 20/32

(52) U.S. Cl. CPC G06Q 50/06; B60L 53/16; B60L 53/665; G06Q 20/18; G06Q 20/3276; B60L 2270/32; G06K 7/1417

(57) ABSTRACT

An electric vehicle charging payment device, system, and method for enabling charger owners to make the chargers available for customers to pay for and use in residential or commercial settings with standard wall outlets. Equipped with a power cord and a standard electric plug, the charger ensures compatibility with any standard wall outlet. A connector cord, attached to a standard EV plug, delivers power to the car. The charger is enhanced with built-in WIFI and/or a SIM card for wireless connectivity, a charger interface displays a unique QR code for EV charger identification and the acceptance of payments through a web-based payment portal. Additionally, an accompanying charger owner application enables robust charger control and pricing configurations. Together, the present disclosure establishes a comprehensive system for convenient EV charging and payment capabilities for the use of EV chargers and electricity in residential or commercial settings.

### CROSS REFERENCE TO RELATED APPLICATION

This application claims the benefit of United States Provisional application of Franck Scozzafava and Ho Ting Wong, application No. 63/548,752, filed Feb. 1, 2024, having the title for WI-FI AND/OR SIM CARD-ENABLED CELLULAR SMART EV CHARGER AND SYSTEM AND METHOD FOR CHARGING ELECTRIC VEHICLES (EVS) WITH AN ELECTRICITY PLUG COMPATIBLE WITH STANDARD WALL OUTLETS, AND FEATURING PAYMENT ACCEPTANCE THROUGH UNIQUE QR CODE SCANS VIA MOBILE, SMARTPHONE CAMERAS, AND WEB-BASED PAYMENT PORTAL, which is incorporated herein by reference in its entirety.

### FIELD OF THE INVENTION

This invention relates to an electric vehicle charging payment device, system, and method of using.

### BACKGROUND

Electric vehicle (EV) chargers are globally prevalent, offered in diverse configurations for both commercial and residential applications, and can be connected to the electrical grid in a multitude of ways.

Commercial chargers that accept payment typically involve professional installation and come with a substantial cost. Home chargers exhibit diverse forms and styles, ranging from professionally installed units to those that can be plugged into a standard electrical outlet.

One notable drawback in the current landscape is the absence of a charger designed to plug into a standard electrical outlet while also offering a convenient method for customers to make payments for both the charger usage and the consumed electricity. This gap leaves homeowners and small business proprietors without a straightforward means to receive compensation for the utilization of an owner's chargers and the electricity supplied.

Thus, a heretofore unaddressed need exists in the industry to address the aforementioned deficiencies and inadequacies.

### SUMMARY

The present disclosure provides systems, devices, and methods for electric vehicle charging payments. The electric vehicle (EV) charger, hereinafter “charger,” of the present disclosure addresses a gap in the market for EV chargers that accept payments but do not plug into standard electrical outlets. Specifically, there is no EV charger available that plugs into any standard outlet and accepts payments through a unique QR code generated on the charger's screen and does not require the download or use of a payment app. The present disclosure offers a versatile solution for various scenarios, including short and long-term rental properties, shared living arrangements, and small businesses.

Whether leasing a property for short or long-term durations or running a small business like a motel or restaurant, this innovative charger offers a convenient solution for guests, roommates, customers, and employees to charge electric vehicles. This is particularly beneficial in areas where commercial EV charging options are limited or distant. Additionally, this disclosure enables property and business owners to generate revenue from both the use of the charger and the electricity consumed. Notably, the simplicity of this solution eliminates the need for costly professional EV charger installation, as it easily plugs into any standard electrical outlet.

In the current EV charger landscape, commercial chargers involve professional installation and often come with a substantial cost. While home chargers come in various forms, from professionally installed units to those plugging into standard electrical outlets, a significant drawback is the absence of a charger designed to plug into a standard outlet and offer a convenient method for customers to make payments for both charger usage and consumed electricity.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The present invention and the manner in which it may be practiced is further illustrated with reference to the accompanying drawings wherein:

FIG. 1 illustrates a perspective view of the charger, according to one embodiment of the present disclosure;

FIG. 2A illustrates a perspective view of the charger housing, according to one embodiment of the present disclosure;

FIG. 2B illustrates a perspective view of the charger housing mount, according to one embodiment of the present disclosure;

FIG. 3A illustrates a perspective view of the vehicle connector mount, according to one embodiment of the present disclosure;

FIG. 3B illustrates a perspective view of the vehicle connector, according to one embodiment of the present disclosure;

FIG. 3C illustrates a perspective view of the vehicle connector coupled with the vehicle connector mount, according to one embodiment of the present disclosure;

FIG. 4A illustrates a perspective view of a three-prong power cord, according to one embodiment of the present disclosure;

FIG. 4B illustrates a perspective view of a two-prong power cord, according to one embodiment of the present disclosure;

FIG. 4C illustrates a perspective view of a four-prong power cord, according to one embodiment of the present disclosure;

FIG. 5A illustrates a perspective view of a power cord in a cord cover, according to one embodiment of the present disclosure;

FIG. 5B illustrates a perspective view of a power cord in a closed cord cover, according to one embodiment of the present disclosure;

FIG. 6A illustrates a perspective view of a payment portal, according to one embodiment of the present disclosure;

FIG. 6B illustrates a perspective view of a payment portal, according to one embodiment of the present disclosure;

FIG. 7A illustrates a perspective view of the charger portal of the owner application, according to one embodiment of the present disclosure;

FIG. 7B illustrates a perspective view of the setting charger page of the owner application of the owner application, according to one embodiment of the present disclosure;

FIG. 8 illustrates in flow diagram form the steps of the charger setup method of the owner application, according to one embodiment of the present disclosure; and

FIG. 9 illustrates in flow diagram form the steps of the customer payment method, according to one embodiment of the present disclosure.

### DETAILED DESCRIPTION OF THE EMBODIMENTS

Reference is now made in detail to the description of the embodiments as illustrated in the drawings. While several embodiments are described in the connection with these drawings, there is no intent to limit the disclosure to the embodiment or embodiments disclosed herein. On the contrary, the intent is to cover all alternatives, modifications, and equivalents.

It should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

The charger of the present disclosure consists of an EV charger with a standard EV plug that connects to an electric or hybrid car and also incorporates a standard electricity plug that plugs into any standard electricity outlet to receive power from the electric grid. The described EV charger displays a unique QR code on a digital screen to link with smartphones and accept payments. The charger is designed for wall attachment or laying flat on the ground. Because the charger plugs into a standard electricity outlet to obtain power, it eliminates the need for an electrician to install it. The EV charger plugs into any standard outlet and incorporates hardware and software technology for connectivity, allowing the charger to connect and be controlled with smartphones through WIFI and/or a SIM card cellular network.

Each EV charger displays a uniquely generated QR code, which customers scan with smartphone cameras, leading to a web-based payment portal accepting various methods such as credit cards, PayPal™, Google Pay™, and Apple Pay™, and more. This architecture eliminates the need for a dedicated application for payment processing by leveraging a QR code-enabled, web-based transactional interface. Customers use the device's camera to scan the provided QR code, which directs them to the web-based payment portal. Customers specify the desired charging duration and review the associated pricing before initiating the payment transaction through the web interface.

Upon payment verification, the charging station autonomously activates the charging sequence. Customers then connect the EV charging plug to the electric vehicle's charging inlet. Upon completion of the charging session, customers receive an SMS/text notification detailing the completion status and including a payment receipt. Any interruptions in the charging process trigger immediate SMS/text alerts to the customer. The charging station owner receives payment via a secure payment portal integrated with the customer's transactional interface. This methodology leverages QR codes and SMS/text notifications to streamline the EV charging process, enhancing customer accessibility and convenience through a technically sophisticated and customer-friendly approach.

The EV charger and system come with an owner application download, allowing EV charger owners to download the application, create an account, set pricing, and input bank account information to receive instant payments.

Multiple chargers can be controlled and monitored through one account on the app. Additionally, the charger is designed for both indoor and outdoor use, featuring rigid, waterproof construction, and is sold with locking electrical outlet boxes/covers to help prevent electricity theft. An accompanying instructional sign may be mounted on a wall or the charger housing with conventional adhesive means. Setup is quick and easy, making it accessible for anyone to install.

The charger device and system for electric vehicles comprises of a charger housing, power cord, and connector cord with vehicle connector. Charger housing has four, generally planar sides, wherein the charger housing is mounted to a wall using a charger housing mount with a power cord connected to the underside of the charger housing, the power cord interfaces with a standard power outlet through a power cord plug. A connector cord for plugging into an electric vehicle is also connected to the underside of the charger housing.

Each vehicle connector has a different charging protocol or connector type wherein each vehicle connector is plugged into a charging port of an electric vehicle being charged. An outlet cover with a locking mechanism secures the power cord to the power outlet to prevent unauthorized unplugging and electricity theft. A QR code displayed on the charger housing, wherein the QR code is uniquely generated for each charger and is scanned by a smartphone camera of a customer to redirect the customer to a web-based payment portal. The web-based payment portal accepts various payment methods allowing the customer to specify a desired charging duration and review associated pricing before initiating the payment transaction. An automated charging initiation module activates the charging sequence upon verification of the payment transaction. A notification module sends a notification to the customer's mobile device upon completion of the charging session, the notification including a payment receipt, indication to add more duration time, and/or sends an alert to the customer's mobile device if any interruption occurs during the charging process wherein a transactional interface to disburse payment to a charging station owner through the web-based payment portal.

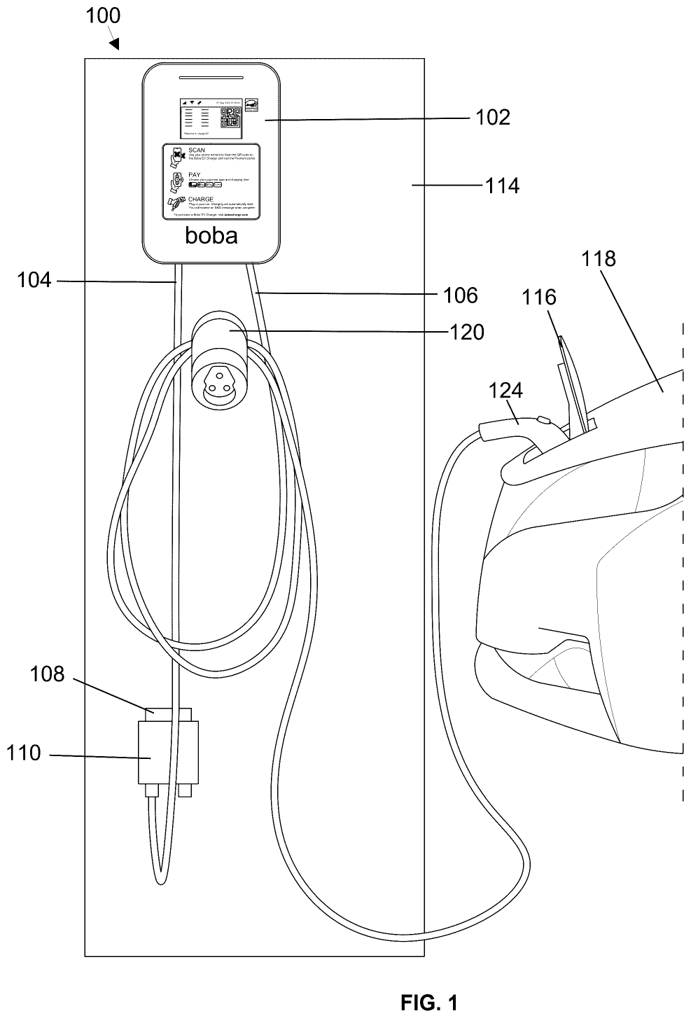

Adverting now to the drawings, FIG. 1 illustrates a perspective view of the charger 100, according to one embodiment of the present disclosure. Charger 100 comprises a charger housing 102, a power cord 104, and a connector cord 106 according to one embodiment of the present disclosure. Here, charger housing 102 is mounted to charger housing mount 112 (not shown) to the wall 114 of a garage. In a preferred embodiment, charger housing 102 has four, generally planar sides, with power cord 104 and connector cord 106 connected to the underside of the charger housing 102. In other embodiments, owner may insert a SIM card into a SIM tray within the charger housing 102 to connect the charger 100 to the internet.

Given electric vehicles require differing charging protocols or connector types, vehicle connectors 124 may differ by charger 100 model to accommodate J1772, Mennekes, CCS, CHAdeMO, and other common connector types. Vehicle connectors 124 are plugged into the charging port 116 of the vehicle 118 being charged. When not in use, vehicle connector 124 is held by an accompanying connector mount 120 according to one embodiment.

Power cord plug 142 of power cord 104 can be plugged into any standard power outlet 108 found in commercial and residential buildings. Since power outlets 108 vary by region, power cords 104 are designed to be compatible with a variety of standard power outlets 108 across different regions. The power cord plug 142 may be of any type, including but not limited to Type B (North America), Type C/E/F (Europe), and other variations, depending on the geographical location. In one embodiment, the power cord 104 and power cord plug 142 are secured to the power outlet 108 using an outlet cover 110 with a locking mechanism to prevent unplugging and electricity theft by guests, employees, or anyone else who brings a residential electric vehicle charger. In other embodiments, power cord plug 142 may be hardwired into a standard wall-mounted outlet or junction box without requiring a plugging into a power outlet 108.

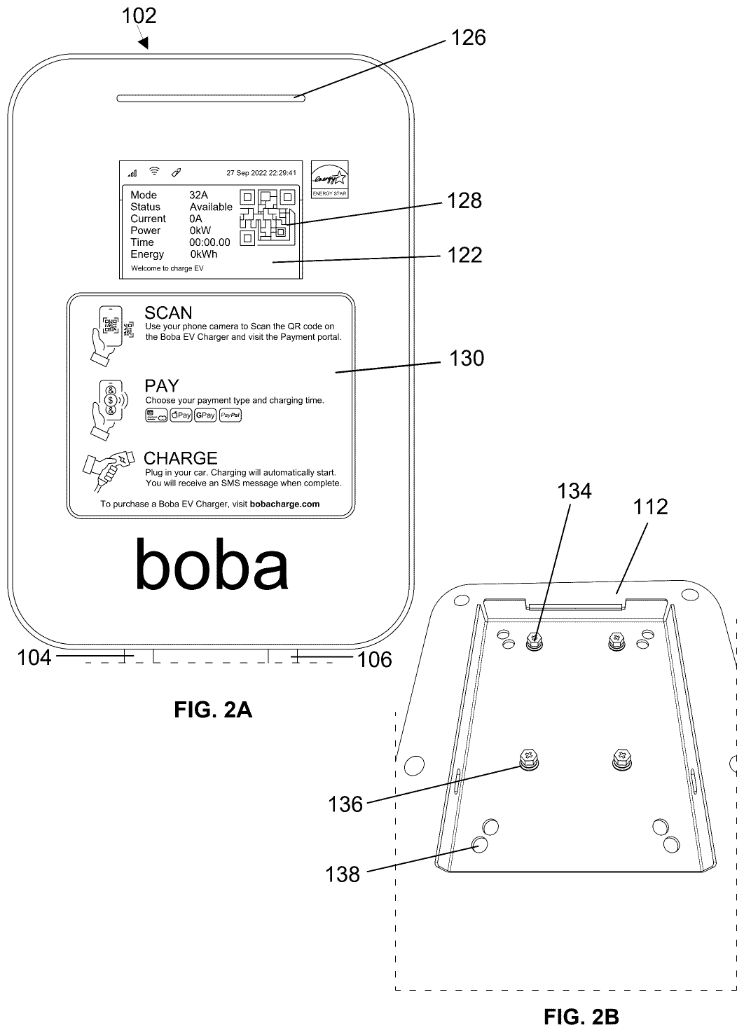

FIG. 2A illustrates a perspective view of the charger housing 102 with charger interface 122, according to one embodiment of the present disclosure. The charger housing 102 is made from waterproof, rigid materials such as plastics, metals, and similar substances. Charger interface 122 is a graphical display providing general information about the charger, including mode, status (available, unavailable, or charging), current, power, time remaining (displayed as “Time”), and energy, along with a QR code 128. Charger interface 122 does not require direct touch input from the customer. An indicator light 126 on charger housing indicates current status of charger 100. For example, indicator light 126 may emit blue if the charger 100 is available for charging or green if the charger 100 is currently charging.

The QR code 128 on the charger interface 122 allows customers to scan the QR code 128 using the camera on a smartphone to access the payment portal, enabling customers to pay for and use the charger for a specified duration time. Additionally, QR code 128 enables owners to add the device to the owner application 300 during initial charger setup. In other embodiments, related optical data matrix systems may be used in lieu of a QR code 128.

In addition to the charger interface 122, the charger housing 102 includes use instructions 130 for customers using the charger 100. These instructions provide information on how to use the charger 100, including steps for scanning the QR code 128 to access the payment portal 202, make a payment, and charge the vehicle. The use instructions 130 may be displayed directly on the charger housing 102 or on a sign attached to the charger housing 102 or wall with common adhesive means.

In a preferred embodiment, the charger housing 102 features four generally planar sides, with the power cord 104 and connector cord 106 connected to the underside of the charger housing 102.

FIG. 2B illustrates a perspective view of the charger housing mount 112, according to one embodiment of the present disclosure. Charger housing mount 112 is used to secure the charger housing 102 to a wall or other smooth surface. Charger housing mount 112 is secured to the wall using securing means 134 such as nuts and bolts through apertures 136 on the charger housing mount 112 and wall surface. Charger housing 102 is then mounted to charger housing mount 112 by securing means 134 such as nuts and bolts through apertures on the rear of charger housing 102 and charger housing mount 112 or a standard bracket mechanism.

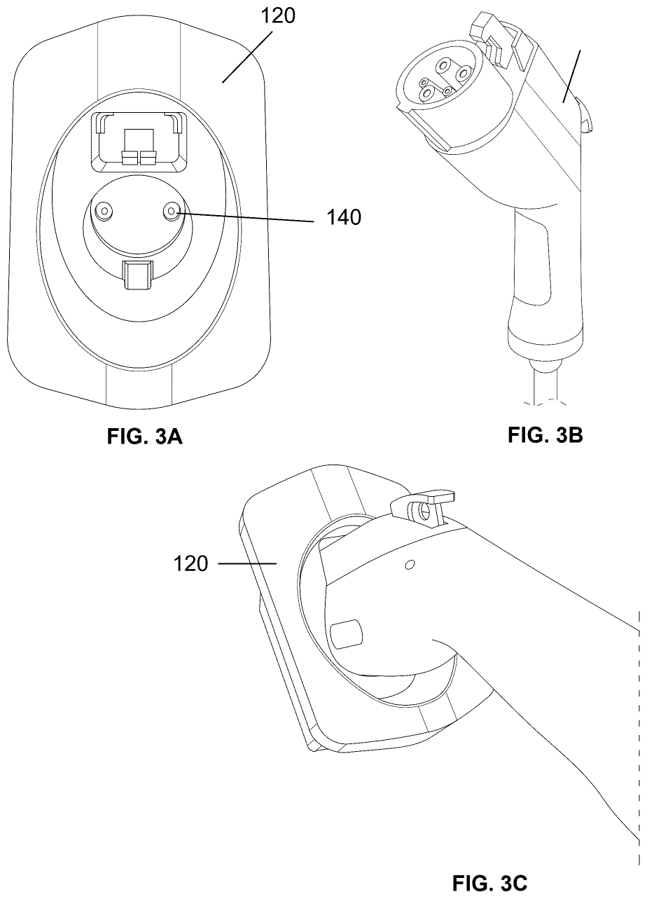

FIG. 3A illustrates a perspective view of the vehicle connector mount 132, according to one embodiment of the present disclosure. Here, securing means 134 such as nuts and bolts are passed through mount hole 140 into a wall or smooth surface for securing the vehicle connector mount 132 to the wall. Vehicle connector mounts 132 are compatible in shape to the vehicle connector 124 being held.

FIG. 3B illustrates a perspective view of a standard vehicle connector 124, according to one embodiment of the present disclosure.

FIG. 3C illustrates a perspective view of the vehicle connector 124 coupled with the vehicle connector mount 132, according to one embodiment of the present disclosure.

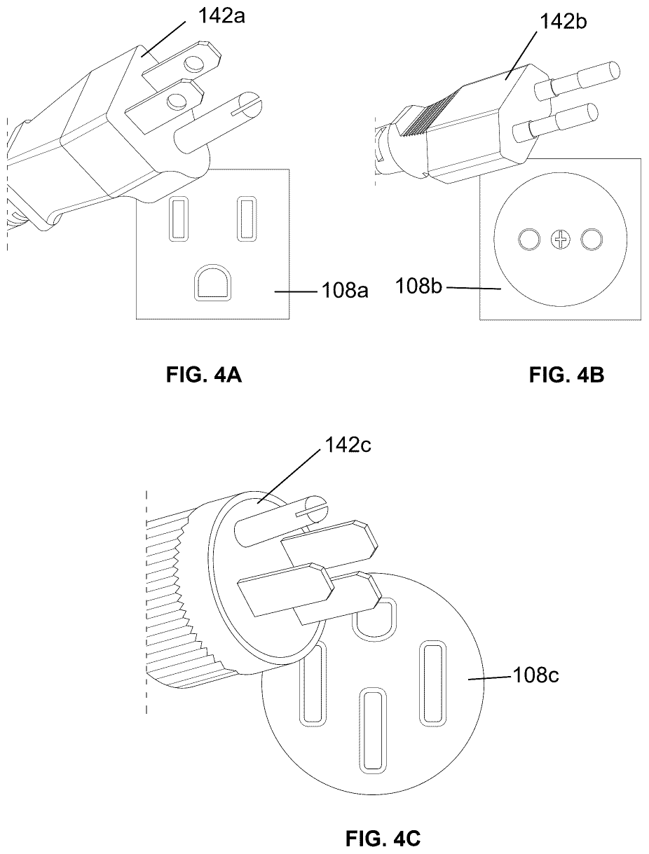

FIG. 4A illustrates a perspective view of a three-prong power cord plug 142a and compatible three-prong outlet 108a, according to one embodiment of the present disclosure.

FIG. 4B illustrates a perspective view of a two-prong power cord plug 142b and compatible two-prong outlet 108b, according to one embodiment of the present disclosure.

FIG. 4C illustrates a perspective view of a four-prong power cord 142c and compatible four-prong outlet 108c, according to one embodiment of the present disclosure.

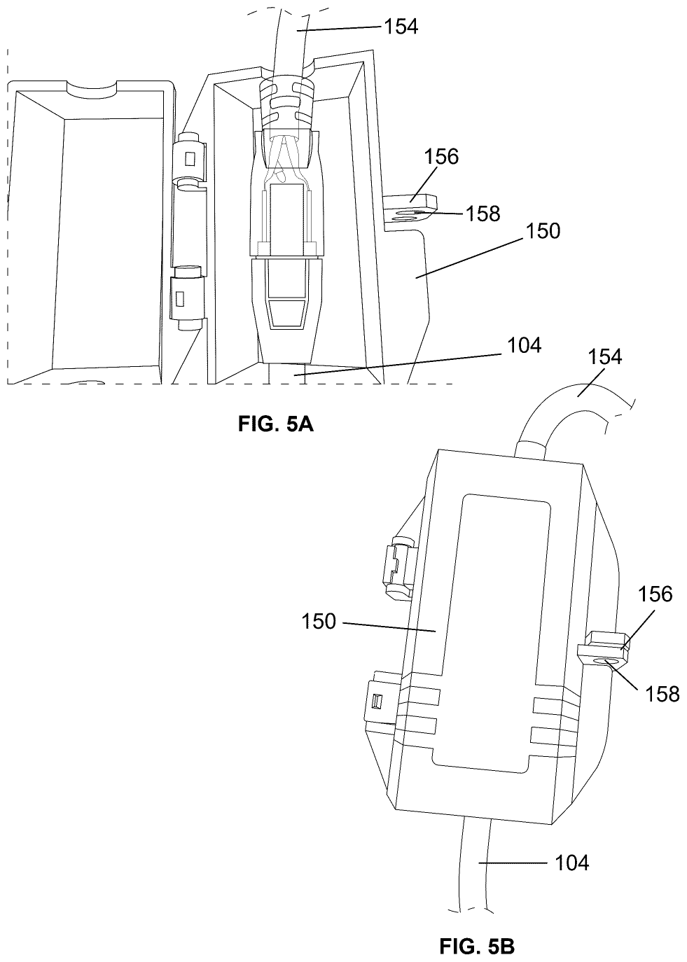

FIG. 5A illustrates a perspective view of a power cord 104 in a cord cover 150, according to one embodiment of the present disclosure. In situations where power outlet 108 is too far for power cord 104 to reach, an extension cord 154 may be used to connect the power cord 104 to a power outlet 108. Given such vulnerability of the power cord 104 and extension cord 154 connection becoming disconnected, a standard cord cover 150 may be utilized. Here, cord cover 150 may have a locking mechanism 156 to secure a lock through lock holes 158 on the cord cover 150. Cord cover 150 prevents both the power cord 104 and extension cord 154 from being disconnected as well as preventing electrical theft.

FIG. 5B illustrates a perspective view of a power cord in a cord cover 150 closed, according to one embodiment of the present disclosure. Cord cover 150 prevents both the power cord 104 and extension cord 154 being disconnected as well as preventing electrical theft.

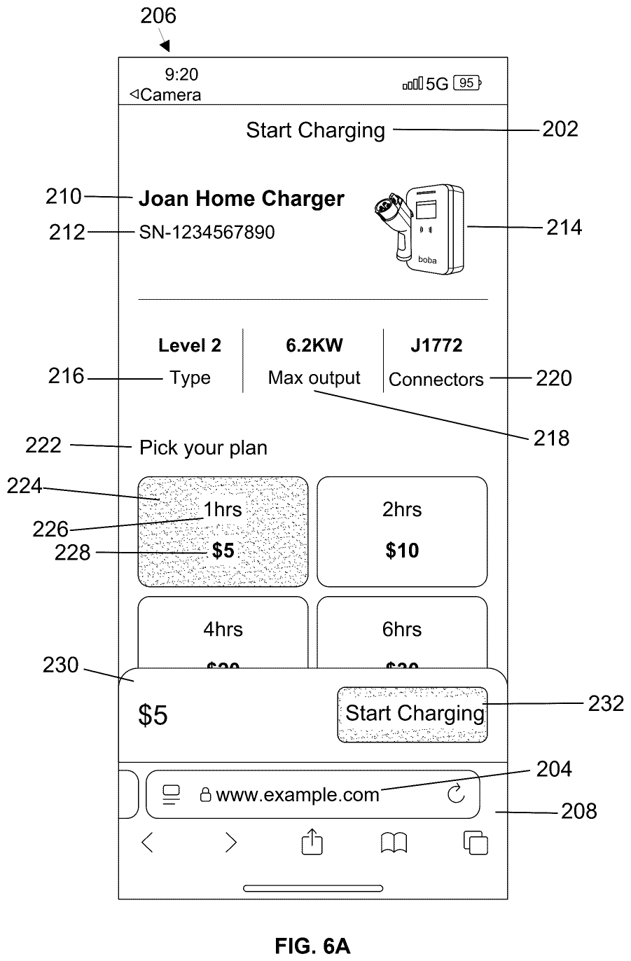

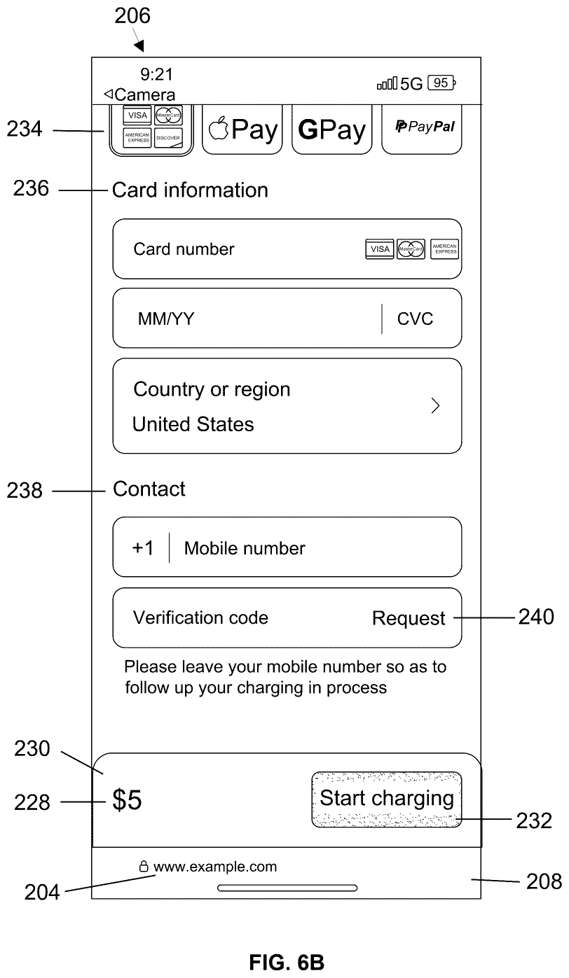

FIG. 6A illustrates a perspective view of the payment portal 202 for use with a smartphone 206 in accordance with an embodiment of the present disclosure. Here, smartphones 206 may extend to computing devices including smart watches, smart glasses, tablets, laptops, personal computers, and the like having cameras or optical scanner capabilities.

Upon scanning a QR code unique to each charger 100 with a smartphone 206 camera, a link 204 encoded by the QR code appears on the smartphone 206 screen. In other embodiments, the owner may provide link 204 directly to the customer. When selected, link 204 directs the customer to the payment portal 202 in the smartphone browser 208. In a preferred embodiment, the payment portal 202 does not require a standalone application, allowing charger 100 reservations to be made entirely through the customer's browser 208.

The payment portal 202 displays the charger name 210, charger serial number 212, and charger model photo 214. Additional information about charger 100 includes the charger type 216, max output 218, and connector type 220. Common charger types 216 may include Level 1, Level 2, and DC Fast. Max output 218 indicates the power output of charger 100, measured in kilowatts (kW). Common connector types 220 may include J1772, Mennekes, CCS, CHAdeMO, and other prevalent types.

As the customer navigates through the payment portal 202, a plan option 224 must be chosen from the plan selection section 222. Plan options 224 include the duration time 226 for which the charger will be reserved and the plan price 228. Charger 100 owners can set the duration time 226 and plan price 228 based on personal preferences. Once a plan option 224 is selected, a sticky navigation bar 230 displaying the plan price 228 and a start charging button 232 will appear at the bottom of the browser 208.

Continuing down the payment portal 202, as depicted in FIG. 6B, the customer is prompted to choose a payment option 234, which may include credit/debit cards, digital payment services like PayPal™, Google Pay™, and Apple Pay™, or cryptocurrencies. Upon selecting a payment option 234, the customer is asked to provide payment information 236, such as card number, expiration date (month/year), CVC, and billing details. For non-card payment options, customers can authorize a digital payment service set up on a smartphone or be directed to the digital payment service provider's login page to authorize the transaction, after which the customer is redirected to the payment portal 202 to complete the payment.

After entering payment information 236, the customer proceeds to the contact information section 238 to input a phone number. For first-time customers, the phone number is confirmed by selecting the request button 240 to receive a verification code via SMS/text message. Once the verification code is entered, the customer selects the start charging button 232 from the sticky navigation bar 230 to secure the reservation for charger 100 and initiate charging. The sticky navigation bar 230 also displays the plan price 228.

Upon initiation, customers receive a confirmation SMS/text message to the smartphone 206. Upon completion of charging or duration time 226, an SMS/text message is sent to the customer, along with an indication in the SMS/text message to add more duration time 226 using link 204.

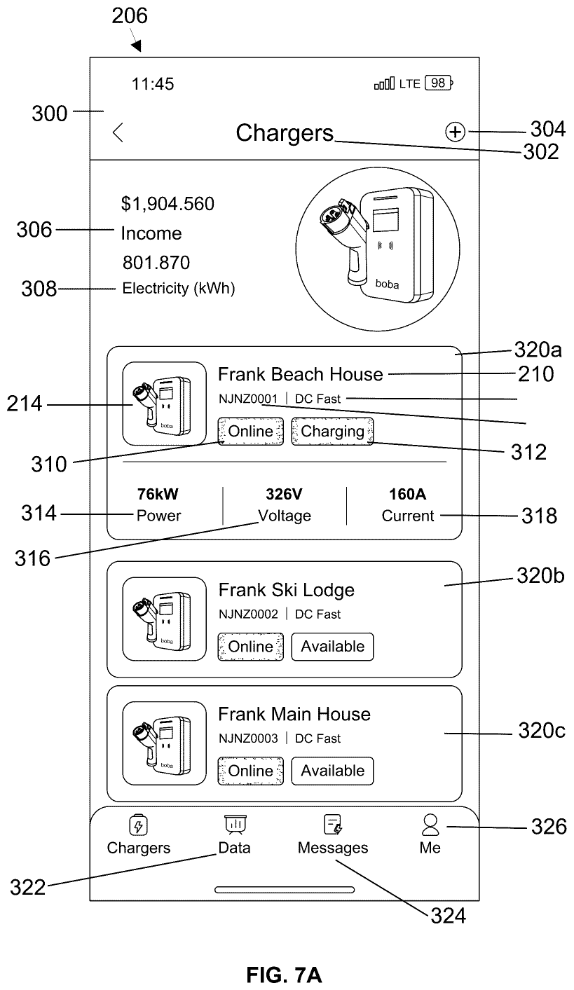

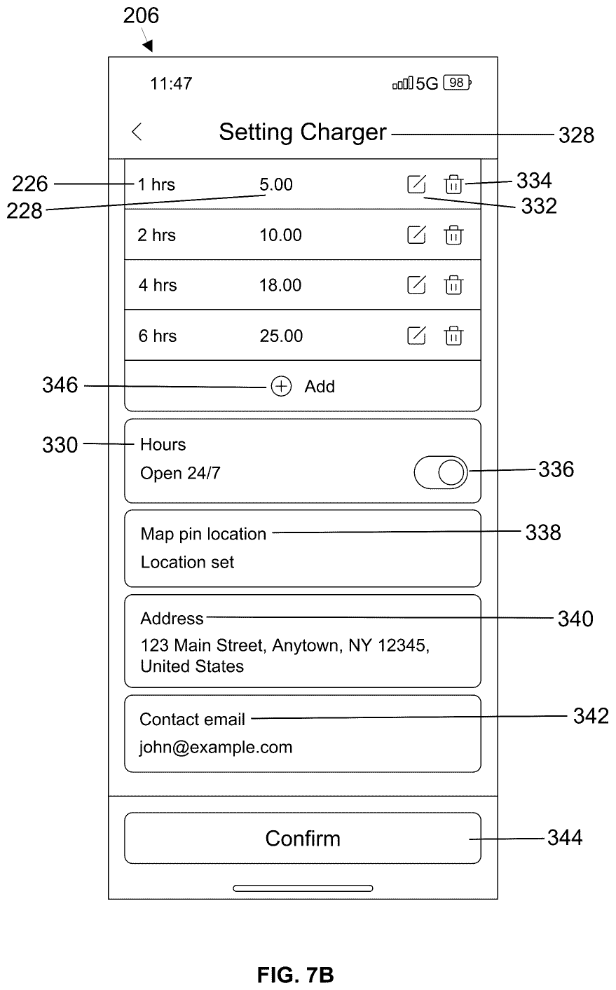

FIG. 7A illustrates a perspective view of the charger portal 302 of the owner application 300 for use with a smartphone 206, according to one embodiment of the present disclosure. Here, smartphones 206 may extend to similar computing devices including smart watches, smart glasses, tablets, laptops, personal computers, and the like. Charger portal 302 provides owners with helpful information and tools necessary to activate and monitor multiple chargers 100 remotely through the owner application 300. In a preferred embodiment, charger portal 302 is a standalone application.

Upon logging into an existing owner account or creating an owner account on the owner application 300, charger owners are directed to the charger portal 302.

Charger portal 302 allows charger owners to configure chargers 100 for use with the payment portal 202 described in FIGS. 6A and 6B. Charger portal 302 provides functionality for owners to monitor chargers 100 and activate additional chargers 100.

To add a new charger 100, the owner selects the add charger button 304 on and is then directed to a page to input the charger serial number 212 or scan the QR code found on the front of the charger 100. Once the new charger is added, the owner is then directed to a page to connect the new charger to a Wi-Fi network by manually entering the Wi-Fi network name and password or by selecting from detected networks available nearby. Once connected to the Wi-Fi network, the owner is then directed to the setting charger page 328, illustrated in FIG. 7B, to set charger details before being redirected back to the charger portal 302 upon adding the new charger.

Charger portal 302 displays income 306 generated from charger customers and electricity used 308 by the chargers. Both income 306 and electricity used 308 may be calculated based on a set period of time such as a day, week, month, etc. Income 306 is displayed in a currency specified by the owner and electricity used 308 is displayed in kilowatt-hours (kWh) in preferred embodiments.

When an owner selects one of the owner chargers 320 in the charger portal 302, further information about the charger including charger power 314, charger voltage 316, and charger current 318 is displayed. Here, charger power 314 is displayed in kilowatts (kW) and indicates how much power is being delivered.

Additional portals within the owner application 300 include a data portal 322 featuring further information on income 306 generated and electricity used 308 over set periods, along with details of each reservation such as charger amount charged, duration of charge, method of payment, customer name, and related information. A message portal 324 provides owners with notifications of new or completed transactions within the application, including details such as amount charged, duration of charge, method of payment, start time, charger number, and related information. Lastly, an owner portal 326 brings charger owners to a page for setting up basic profile information such as name, address, and contact information, as well as adding banking details for withdrawals. Owners can configure general app settings within the owner portal 326.

FIG. 7B illustrates a perspective view of the setting charger page 328 within the owner application 300 for use with a smartphone 206, according to one embodiment of the present disclosure. The setting charger page 328 is accessed when adding a new charger 100 as described in FIG. 7A. Existing charger settings for charger 100 may also be configured on the setting charger page 328. On this page, charger owners can set or change the charger name 210, charger map pin location 338, charger location address 340, owner contact email address 342, and charger availability hours 330, or indicate whether the charger 100 is available 24/7 by selecting the 24/7 button 336. When charger map pin location 338 is selected, charger owners can drag a virtual pin on a provided map to indicate the exact location of charger 100. This feature using the charger map pin location 338 is useful in instances where charger 100 is in a location relatively distant from the charger location address 340, such as a detached garage or parking lot.

Charger owners can modify plan options 224 for charger(s) 100, including duration time 226 and plan prices 228, by using the edit plan button 332 or deleting plan options 224 through the delete plan button 334 next to each plan option 224. Additional plan options 224 can be added via the add plan button 346. After configuring the plan option 224 settings, the charger owner selects the confirm button 344 to save the configuration.

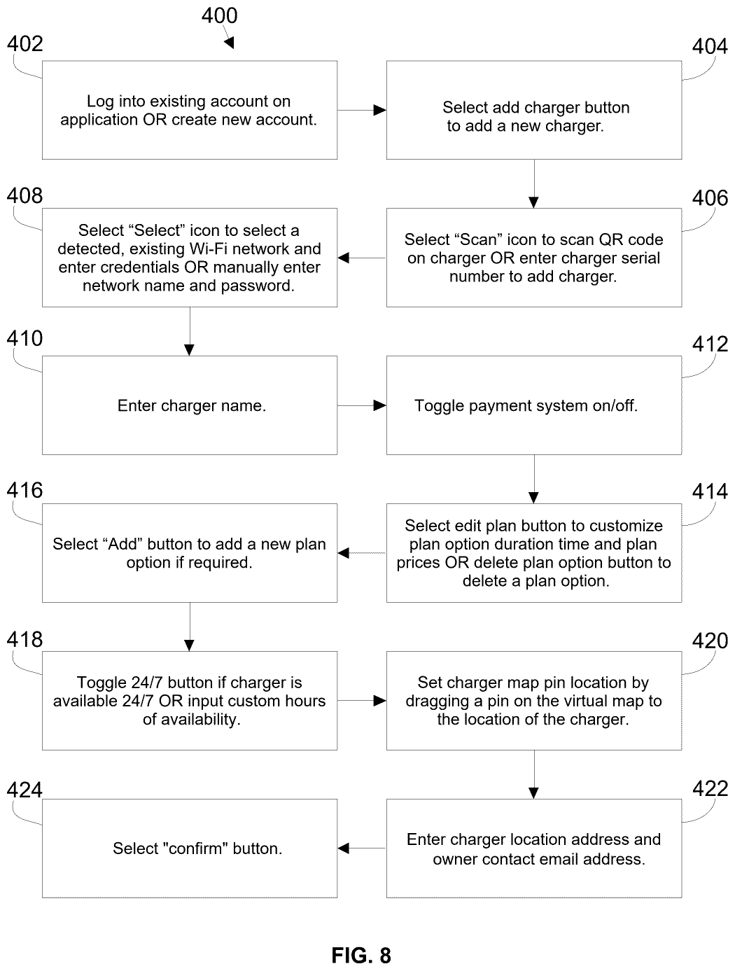

FIG. 8 illustrates a flowchart of the charger setup method 400 of the owner application 300, according to one embodiment of the present disclosure. While steps 402-422 are required for adding a new charger 100, steps 410-422 are applicable for existing owner chargers 320 where an owner may want to update charger settings from the setting charger page 328.

Following downloading the owner application 300 from a preferred mobile application store, in Step 402, the owner logs into an existing account on the owner application 300 or creates an account. Account creation, at minimum, requires a contact email/phone number and password. Once logged in, the owner is directed to the setting charger page 328.

In step 404, the owner selects the add charger button 304 on the setting charger page 328 and is then directed to a page to add the charger 100.

In step 406, the owner inputs the charger serial number 212 or selects “scan” to scan the QR code 128 found on the front of the charger 100 using the camera of a smartphone to add the charger 100. Once the charger 100 is added, the owner is then directed to a page to connect the charger 100 to a Wi-Fi network.

In step 408, the owner manually enters the Wi-Fi network name and password or selects from detected Wi-Fi networks available nearby. In other embodiments, the owner may insert a SIM card into a SIM tray within the charger housing 102. Once connected to the Wi-Fi network, the owner is then directed to the setting charger page 328.

In step 410 on the setting charger page 328, owner sets the charger name 210. The charger name is of the owner's choosing.

In step 412, owner toggles the payment on/off button 440 on the setting charger page 328 to “on” or “off.” When payment on/off button 440 is toggled “on,” charger 100 requires payment to reserve and use the charger. This may be turned “off” however in instances where the owner determines the charger 100 can be used without requiring payment such as by the owner for personal use.

In step 414, the owner selects edit plan button 332 to customize duration time 226 and plan price 228 for plan options 224 on the setting charger page 328. Duration time 226 and plan price 228 may be set to any value determined by the owner. Here, duration time 226 is the amount of time available to the customer to use the charger 100 and plan price 228 is the price of using the charger 100 for the selected duration time. Duration time 226 may be, for example, 15 minutes, 1 hour, 6 hours, 12 hours, etc. In step 414, owners may also delete plan options 224 by selecting the delete plan button 334.

In step 416, owners may add plan options 224 by selecting the add plan button 346 on the setting charger page 328. This may be useful for owners that want to add a variety of plan options 224 tailored to the owner's own preferences or customer needs.

In step 418, owners may toggle the 24/7 button 336 “on” or “off” on the setting charger page 328 to make the owner's charger 100 available to customers 24/7. If the 24/7 button 336 is toggled “on,” an owner makes the charger available 24/7 for customers. If the 24/7 button 336 is toggled “off,” the owner may set charger availability to certain hours either on any given day or specific days. For example, no charger availability on weekends or holidays or available 9 AM to 5 PM on weekdays.

In step 420, the owner can set the charger map pin location 338 on a virtual map by dragging a virtual pin to the precise location of charger 100 relative to the charger location address 340 on the setting charger page 328. This is beneficial in cases where the charger 100 location is relatively distant from the charger location address 340, such as in a detached garage or auxiliary parking lot.

In step 422, the owner enters the charger location address 340 as well as an owner contact email address 342 on the setting charger page 328. Charger location address 340 is the address of the building or home the charger 100 is located. Owner contact email address 342 is used for correspondence specific to the charger 100 at a given charger location address 340.

In step 424, once the owner is satisfied with the plan option 224 settings on the setting charger page 328, the owner selects the confirm button 344 to save the settings configuration.

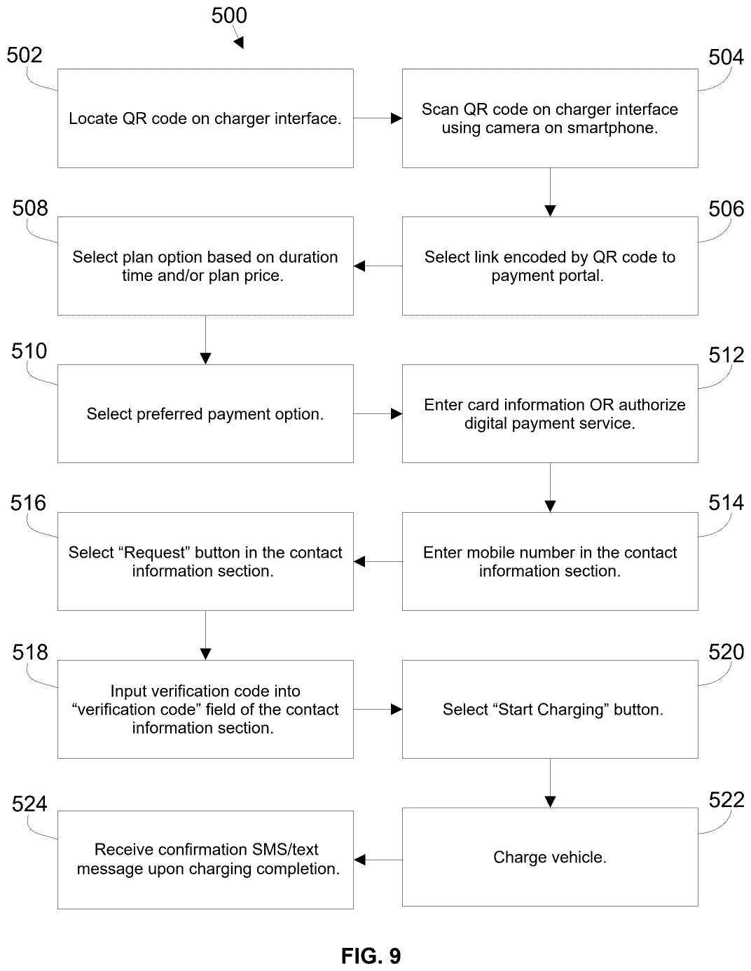

FIG. 9 illustrates in flow diagram form the steps of the customer payment method 500, according to one embodiment of the present disclosure. Customer payment method 500 involves the steps required for a customer to reserve and pay for the plan option 224 of a charger 100.

In step 502, the customer locates the QR code 128 on the charger interface 122 of the charger housing 102. The charger interface 122 and accompanying QR code 128 is located on the front of the charger housing 102.

In step 504, using the camera of a smartphone 206, the customer scans the QR code 128. When the QR code 128 is scanned, the camera displays a link 204 stored by the QR code 128. The link 204 typically populates on the screen of the smartphone 206.

In step 506, the customer selects the link 204, which directs to the payment portal 202 in the browser 208 of the smartphone 206.

In step 508, the customer is presented with a variety of plan options 224 in the payment portal 202 set by the charger owner and the customer selects a plan option 224. Each plan option 224 indicates a duration time 226 and plan price 228.

In step 510, after choosing a plan option 224 in the payment portal 202, the customer selects a preferred payment option 234, which may include credit/debit cards, digital payment services such as PayPal™, Google Pay™, and Apple Pay™, or cryptocurrencies.

In step 512, the customer is prompted to enter payment information 236, which may include card number, expiration date, CVV code, and billing details for debit/credit card payment options. For non-card payment options such as digital payment services, upon selecting, customers may be redirected to an authentication interface provided by the selected payment service to authorize the transaction using pre-stored financial information and redirected back to the payment portal 202 upon authorization.

In step 514, the customer enters a mobile phone number in the contact information section 238.

If the customer is a first-time customer using the payment portal 202, in step 516, the mobile phone number is confirmed by selecting the request button 240 in the contact information section 238 to receive a verification code via SMS/text message.

In step 518, the first-time user then enters the verification code received in the “verification code” field of the contact information section 238.

Upon completion of the required information in the payment portal, in Step 520, customer selects the start charging button 232 from the sticky navigation bar 230 to secure the reservation for charger 100 and initiate charging.

In step 522, customer's vehicle 118 is charged for the duration time 226 of the selected plan option 224 in the payment portal 202.

Following completion of the duration time 226, the customer receives an SMS/text message upon completion of the duration time 226. SMS/text message may provide an indication or link to add more time if the vehicle 118 is not fully charged.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. A charging device and system for electric vehicles, comprising:
a charger housing having four generally planar sides, wherein the charger housing is mounted to a wall using a charger housing mount;
a power cord connected to an underside of the charger housing, the power cord interfaces with a standard power outlet;
a connector cord connected to the charger housing;
a plurality of vehicle connectors, each vehicle connector has a different charging protocol or connector type wherein each vehicle connector is plugged into a charging port of an electric vehicle being charged;
an outlet cover with a locking mechanism to secure the power cord to the power outlet to prevent unauthorized unplugging and electricity theft;
an optical data matrix system displayed on the charger housing, wherein the optical data matrix system is uniquely generated for each charger and is scanned by a smartphone camera of a customer to redirect the customer to a web-based payment portal, wherein the web-based payment portal accepts various payment methods allowing the customer to specify a desired charging duration and review associated pricing before initiating the payment transaction;
an automated charging initiation module that activates the charging sequence upon verification of the payment transaction;
a notification module that sends a notification to the customer's mobile device upon completion of the charging session, the notification including a payment receipt, and sends an alert to the customer's mobile device if any interruption occurs during the charging process; and
a transactional interface to disburse payment to a charging station owner through the web-based payment portal.

2. The charging apparatus of claim 1, wherein the power cord is hardwired into a standard wall-mounted outlet or junction box without requiring plugging into a power outlet.

3. The charging apparatus of claim 1, wherein the charger housing further comprises a SIM tray, allowing the charging station owner to insert a SIM card to connect the charger to the internet.

4. The charging apparatus of claim 1, wherein the charger housing has an indicator light which changes color based on charger availability.

5. The charging apparatus of claim 1, wherein the optical data matrix system is a QR code.

6. A method for configuring a charger for payment using a mobile application, the method comprising the following steps:
downloading an owner application from a mobile application store;
logging into an existing account on the owner application or creating an account;
directing the owner to a setting charger page upon successful login;
selecting an add charger button on the setting charger page and navigating to a page to add the charger;
inputting charger information on the setting charger page;
directing the owner to a page to connect the charger to a Wi-Fi network;
connecting the charger to the Wi-Fi network;
directing the owner to the setting charger page after successful network connection;
assigning a name to the charger on the setting charger page;
toggling a payment on/off button to “on” to activate ability to receive payments on the setting charger page;
customizing plan options on the setting charger page;
setting charger availability hours on the setting charger page;
setting a charger map pin location on the setting charger page;
entering the charger location address and an owner contact email address on the setting charger page; and
confirming settings on the setting charger page.

7. The method of claim 6, wherein the inputting of charger information comprises inputting a charger serial number or scanning a QR code found on a charger housing using a camera of a smartphone to add the charger.

8. The method of claim 6, wherein the connecting the charger to the Wi-Fi network comprises entering a Wi-Fi network name and password, selecting from a detected Wi-Fi network, or inserting a SIM card into a SIM tray within the charger housing for network connectivity.

9. The method of claim 6, wherein the toggling the payment on/off button to “off” comprises use of the charger without requiring payment.

10. The method of claim 6, wherein customizing plan options on the setting charger page comprises selecting an edit plan button to change a duration time or a plan price, deleting a plan option by selecting a delete plan button, or adding a plan option by selecting an add plan button on the setting charger page.

11. The method of claim 6, wherein setting charger availability hours on the setting charger page comprises toggling a 24/7 button “on” or “off” on the setting charger page, wherein toggling “on” makes the charger available to customers 24/7, and toggling “off” allows setting charger availability for specific hours or days.

12. The method of claim 6, wherein setting a charger map pin location on the setting charger page comprises dragging a virtual pin on a virtual map to a precise location of the charger relative to the charger location address.

13. The method of claim 6, wherein confirming settings on the setting charger page comprises selecting a confirm button to save the settings configuration once the owner is satisfied with the plan options.

14. A method for facilitating customer payment for reserving and using a charger, the method comprising the steps of:
locating the charger by a customer having a computing device;
interfacing the computing device with the charger;
selecting the link, which directs to a payment portal in a browser of the computing device;
presenting plan options in the payment portal;
selecting a plan option in the payment portal;
selecting a payment option;
entering payment and contact information;
confirming and starting charge;
charging the vehicle in accordance with a selected plan option; and
communicating with the customer upon completion of charging.

15. The method of claim 14, wherein the interfacing the computing device with the charger comprises scanning an optical data matrix system of the charger with a computing device.

16. The method of claim 15, wherein the optical data matrix system comprises a QR code having a stored link to a payment portal.

17. The method of claim 14, wherein the interfacing the computing device with the charger comprises selecting a link stored by the optical data matrix on a screen of the computing device.

18. The method of claim 14, wherein plan option comprises a duration time and a plan price.

19. The method of claim 14, wherein payment option comprises credit/debit cards, digital payment services, or cryptocurrencies.

20. The method of claim 14, wherein entering payment and contact information comprises verifying a mobile phone number by selecting a request button to receive a verification code via SMS/text message and entering the verification code in the contact information section.
